(19) United States
(12) Patent Application Publication
(10) Pub. No.: US 2003/0179863 A1
(43) Pub. Date: Sep. 25, 2003

(54) Multiplatform synthesized voice message system

(75) Inventor: William F. Wescott, Woodinville, WA (US)

Correspondence Address: Gil G. Silberman, GENESIS LLP, Suite 207, 1717 17th Street, San Francisco, CA, 94103, US

(73) Assignee: BRAINOXYGEN, INC

(21) Appl. No.: 10/393,811

(22) Filed: Mar. 19, 2003

Related U.S. Application Data
(60) Provisional application No. 60/366,133, filed on Mar. 19, 2002.

(51) Int. Cl. H04M 11/00

(52) U.S. Cl. 379/88.16

(57) ABSTRACT

A synthesized voice message system, comprised of a message storage block and a text-to-speech block which are interconnected, forming a “voicemasks” product which enables the transmission and receipt of synthesized voice messages to and from users using an e-mail server, or an internet server, or a computer telephony server for fixed or cellular phones which can be part of a local telephone company system or a stand-alone system according to selected voice parameters.

This application claims priority from U.S. Provisional Application No. 60/366,133, filed Mar. 19, 2002.

1. Field of the Invention

The present invention is a multi-platform synthesized voice message system, or more specifically, a message system that allows the selection of preestablished voice parameters creating synthesized voice generation characters.

2. Description of Related Art

It is well known that there are a number of systems for voice processing via telephone and computer that are currently used, including those which are basically composed of processors that allow for automated speech recognition through telephone connections by evaluating, tabulating and identifying words as well as using alpha-numeric commands.

There are also voice processors that interface through the telephone with Internet platforms, recognizing and associating specific, pre-established voice parameters with voice commands which are part of a computer based system, enabling the conversion of voice commands to text and vice versa.

One of the objectives of this invention is to provide a messaging system with a synthesized voice that allows the user to take a standard or personalized text message and transform it into an audio message using synthesized voice following pre-established parameters and transformation rules.

Another objective of this invention is to provide a synthesized voice messaging system that allows a message that a user composes on the internet, through e-mail, through a fixed telephone line, or through a cell phone (with or without WAP or similar system) to be accessed by other users as an audio voice message created by a voice synthesizer following defined parameters input by the user and delivered by e-mail, voicemail, or directly delivered to a telephone.

Another objective of this invention is to provide a synthesized voice messaging system that instantly transmits audio messages according to the specific characteristics and pre-established parameters selected by the user.

Another objective of this invention is to provide a synthesized voice messaging system that allows the transmission of voice messages using voice “characters” that the user selects from a predefined group or the user defines by setting specific voice parameters.

Another objective of this invention is to- provide a synthesized voice messaging system that combines elements of prerecorded voice or sound effects, pre-programmed synthesized voice, and instantaneous voice synthesis from text to create and send messages that can be received through various platforms such as fixed telephone, cell phone, e-mail, and internet.

### III. SUMMARY OF THE INVENTION

These and other objectives and benefits of this convention are achieved through a voice messaging system that consists of a voice message storage block and a text-to speech (TTS) application server block. These blocks are interconnected to provide what is called a “voicemasks ” product that is able to receive, store, and transmit messages from and to users through an e-mail server, an intranet server, or a computer telephony server (CT server) for fixed or cellular phones, which can be an independent system or could be part of the local telephone system.

### IV. BRIEF DESCRIPTION OF THE DRAWINGS

The purpose and advantages of the present invention will be apparent to those skilled in the art from the following detailed description in conjunction with the appended drawings, which show a preferred embodiment and in which:

FIG. 1 shows the block diagram of the synthesized voice messaging system as configured independently of the local telephone company servers;

FIG. 2 shows of block diagram of the synthesized voice messaging system integrated into the local telephone company servers;

FIG. 3 shows a block diagram which illustrates how a synthesized voice messages can be originated and be received across different platforms.

### V. DETAILED DESCRIPTION OF THE PREFERRED EMBODIMENTS

Reference will now be made in detail to preferred embodiments of the invention. It is understood that these examples are not intended to limit the invention to one preferred embodiment or application. On the contrary, this application is intended to cover alternatives, modifications, and equivalents. Various modifications to the present invention will be readily apparent to one of ordinary skill in the art, and can be made to the described embodiments within the spirit and scope of the invention as defined by the appended claims.

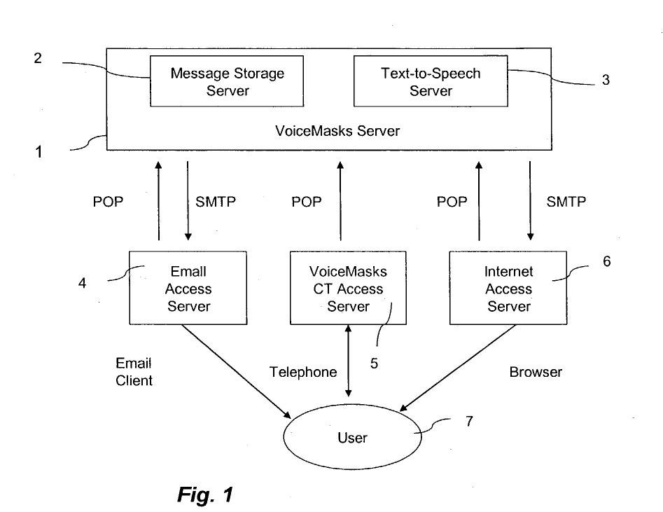

With reference to FIG. 1, the synthesized voice messaging system, the subject of this invention, is comprised of:

the “VoiceMasks” server 1, which has two components: a message storage server 2 that accepts access protocols through e-mail, internet, fixed for cellular phones, or WAP; and a text-to-speech server 3 that converts text messages to voice messages according to selected parameters. Interfaces between these blocks that allow users to transmit and receive messages.

The interaction between the user and this “voicemasks” product, comprised of the above mentioned blocks, can occur through an e-mail server 4 through which a user can submit an e-mail message via POP3 (Post Office Protocol) for the product to process and the recipients can receive a message through e-mail via SMTP (Simple Mail Transfer Protocol), internet, fixed or cellular phone.

The interaction between the user and this VoiceMasks server can also occur through the Voicemasks Computer Telephony (CT) Access server 5 for fixed line telephones via DTMF (Dual-Tone Multifrequency) input and for cellular phones via DTMF and Wireless Application Protocol (WAP) interfaces.

The interaction between the user and this VoiceMasks server can also occur through an intranet server 6 via internet browsers on fixed or mobile devices.

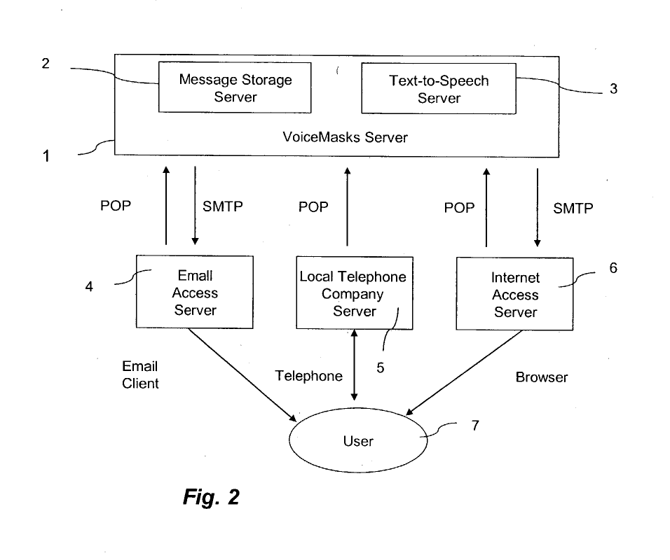

As FIG. 2 illustrates, another architecture through which the interaction between the user and this “voicemasks” product can occur is through a local telephone company that hosts all or part of the voicemasks product so that the users can call a designated number and access their voice mail. In this situation there are the following components to the VoiceMasks system:

the “VoiceMasks” server 1, which has two components: a message storage server 2 that accepts access protocols through e-mail, internet, fixed for cellular phones, or WAP; and a text-to-speech server 3 that converts text messages to voice messages according to selected parameters. Interfaces between these blocks that allow users to transmit and receive messages.

The interaction between the user and this “voicemasks” product, comprised of the above mentioned blocks, can occur through an e-mail server 4 through which a user can submit an e-mail message via POP3 (Post Office Protocol) for the project to process and the recipients can receive a message through e-mail via SMTP (Simple Mail Transfer Protocol), internet, fixed or cellular phone.

The interaction between the user and this VoiceMasks server can also occur through the Local Telephone Company Server 5 for fixed line telephones via DTMF (Dual-Tone Multifrequency) input and for cellular phones via DTMF and Wireless Application Protocol (WAP) interfaces. The Local Telephone Company Server can include a voice message server that can be used to store and access the messages stored in the VoiceMasks Message Storage Server 2.

The interaction between the user and this VoiceMasks server can also occur through an intranet server 6 via internet browsers on fixed or mobile devices.

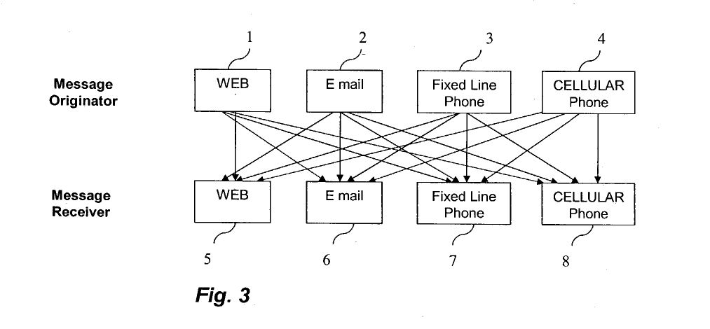

FIG. 3 shows that a message can be generated via a web browser 1, email 2, fixed line phone 3, or cellular phone 4 and be received via a web browser 5, email 6, fixed line phone 7, or cellular phone 8.

With this VoiceMasks synthesized voice messaging system, a voice message can be produced by selecting options from the following parameters:

Gender (male, female);

Age (child, adult, eldery);

Emotions (happy, sad, angry, tired);

Speed (slow, fast, normal);

Volume (high, low, normal);

Language (Portuguese, Spanish, American English, British English, German, French, Italian).

For notification of receipt of voice messages there are three options:

1. Voice mail—the converted message is sent to the voice mail account of the recipient. This requires the support of the telephone company for the company that provides the voice mail system. The software must be integrated with the voicemail system.

2. SMS (Short Message Service)—the recipient days and notified that a message has been received through their cell phone equipped with a SMS function. The recipient can receive the message by calling a specified number, by accessing their account on the Internet, by accessing their voice mail account, or through their e-mail account. In this case, the notification that a “voicemasks” message has been received is handled through the CT server.

3. E-mail—The recipients can be notified about a message has been received through their e-mail system. The “voicemasks” message can then be received by calling a specified number, by accessing their account on the Internet, by accessing their voice mail account, or through their e-mail account.

The “voicemasks” server is the core of the system. It is responsible for the storage of the messages and the conversion of the voice format and integration with the access servers.

Although the foregoing invention has been described in detail for purposes of clarity of understanding, it will be apparent that certain changes and modifications may be practiced within the scope of the appended claims. It should be noted that there are alternative ways of implementing the present invention. It is therefore intended that the following appended claims be interpreted as including all such alterations, permutations, and equivalents as fall within the spirit and scope of the present invention.

### VI. References

None

What is claimed is:

1. A synthesized voice message system, comprising: message storage block and a text-to speech block which are interconnected, forming a “voicemasks” product which enables the transmission and receipt of messages to and from users using one or more servers chosen from a list that includes an e-mail server, an internet server, or a computer telephony server for fixed or cellular phones which can be part of a local telephone company system or a stand-alone system.

2. The synthesized voice message system of claim 1 wherein said message storage block receives input parameters through e-mail, wherein said text-to-speech block enables the conversion of text messages to synthesized voice messages according to specified parameters, and wherein said blocks are interconnected and able to receive and transmit messages to a user directly or through a local telephone company.
